(19) United States
(12) Patent Application Publication
(10) Pub. No.: US 2023/0093841 A1
(43) Pub. Date: Mar. 30, 2023

(54) ELECTROCHEMICAL DEVICE HAVING AT LEAST ONE GELLED ELECTRODE

(71) Applicants: Solvay SA, Brussels (BE); COMMISSARIAT A L' ENERGIE ATOMIQUE ET AUX ENERGIES ALTERNATIVES, Paris (FR)

(72) Inventors: Marc-David Braida, Bry-Sur-Marne (FR); Dominique Bascour, Grez-Doiceau (BE); Julio A. Abusleme, Saronno (IT); Hélène Rouault, Le Versoud (FR); Benjamin Amestoy, Grenoble (FR); Gaëlle Besnard, Grenoble (FR); Côme-Emmanuel Leys, Paris (FR); Jérémie Salomon, Villard-De-Lans (FR)

(73) Assignees: Solvay SA, Brussels (BE); COMMISSARIAT A L' ENERGIE ATOMIQUE ET AUX ENERGIES ALTERNATIVES, Paris (FR)

(21) Appl. No.: 17/792,113

(22) PCT Filed: Jan. 8, 2021
(86) PCT No.: PCT/EP2021/050215

§ 371 Date: Jul. 11, 2022

(30) Foreign Application Priority Data
Jan. 10, 2020 (EP) 20151214.2

(51) Int. Cl. H01M 4/60; H01M 10/0525; H01M 10/0567; H01M 10/0569; H01M 4/04; H01M 10/0568; H01M 50/46; H01M 50/491; H01M 50/414

(52) U.S. Cl. CPC H01M 4/604; H01M 10/0525; H01M 10/0567; H01M 10/0569; H01M 4/0435; H01M 10/0568; H01M 50/46; H01M 50/491; H01M 50/414; H01M 2004/023

(57) ABSTRACT

The present invention relates to an electrochemical device comprising a) a positive electrode, b) a negative electrode, c) a separator, and d) a liquid electrolyte, wherein at least one of said positive electrode and said negative electrode is a gelled electrode comprising an electronic conductive substrate and directly adhered onto the electronic conductive substrate, at least one layer of a gelled electrode-forming composition, and wherein the d) liquid electrolyte comprises at least one organic carbonate and/or at least one ionic liquid, and at least one metal salt. The present invention also relates to a process for manufacturing an electrochemical device comprising at least one gelled electrode.

### CROSS-REFERENCE TO RELATED APPLICATION

This application claims priority to European patent application No. 20151214.2 filed on Jan. 10, 2020, the whole content of this application being incorporated herein by reference for all purposes.

### TECHNICAL FIELD

The present invention relates to an electrochemical device comprising a) a positive electrode, b) a negative electrode, c) a separator, and d) a liquid electrolyte, wherein at least one of said positive electrode and said negative electrode is a gelled electrode comprising an electronic conductive substrate and directly adhered onto the electronic conductive substrate, at least one layer of a gelled electrode-forming composition, and wherein the d) liquid electrolyte comprises at least one organic carbonate and/or at least one ionic liquid, and at least one metal salt. The present invention also relates to a process for manufacturing an electrochemical device comprising at least one gelled electrode.

### BACKGROUND OF THE INVENTION

For more than two decades, Lithium batteries have retained dominant position in the market of rechargeable energy storage devices due to their many benefits comprising light-weight, reasonable energy density and good cycle life.

A liquid electrolyte is a substance which produces an electrically conducting solution when it is dissolved in a polar solvent. The dissolved electrolyte splits into cations and anions, which disperse through the solvent in a uniform manner. Such a solution is electrically neutral, and conducting ionically and electronically insulating.

Basic requirements to be a suitable electrolyte for an electrochemical cell include high ionic conductivity, (electro)chemical stability, and safety. The conventional electrolyte, which is in liquid, has played an essential and dominant role in the field of electrochemical energy storage for several decades due to its high ionic conductivity and good interface with electrodes. However, such a liquid electrolyte has brought safety issues caused by its leakage and inherent explosive nature, e.g., combustion of the organic solvent, generating volatile gaseous species, which are flammable.

That is, Li-ion batteries have suffered from poor safety and relatively low energy density with respect to the required energy density for high power applications such as electrical vehicles (EVs), hybrid electrical vehicles (HEVs), grid energy storage, etc. and the presence of liquid electrolyte is at the basis of such shortcomings.

Accordingly, safety has been a prerequisite for batteries. Several protective mechanisms have been considered as measures to ensure battery safety. External protection relies on electronic devices such as temperature sensors and pressure vents, which eventually increase the volume/weight of the battery and are unreliable under thermal/pressure abuse conditions. Internal protection schemes focus on using intrinsically safe materials for battery components and are hence considered to be the more appropriate solution for battery safety.

Subsequently, hybrid organic/inorganic polymer composites where inorganic materials on a nano-scale or molecular level are dispersed in organic polymers have raised a great deal of scientific, technological and also industrial interests, because of the unique properties they have. Hybridization of organic and inorganic compounds is an evolutionary manner to create a polymeric structure, notably to increase mechanical properties. In this regards, it is well known that a sol-gel process using metal alkoxides is the most useful and important approach, in elaborating hybrid organic/inorganic polymer composites. In particular, the hydrolysis and condensation of metal alkoxides in the presence of pre-formed organic polymers, starting from fluoropolymers, in particular from vinylidene fluoride (VDF) polymers can be properly controlled to obtain hybrid organic/inorganic polymer composites with improved properties in comparison with the original organic and inorganic compounds. The polymer as organic compound may enhance the toughness and processability of inorganic materials, i.e., metal alkoxides, which are brittle in general, wherein the inorganic network may enhance scratch resistance, mechanical properties and surface characteristics of the resulting hybrid organic/inorganic polymer composite.

In particular, WO 2015/169834 (SOLVAY SA and COMMISSARIAT A L'ENERGIE ATOMIQUE ET AUX ENERGIES ALTERNATIVES) discloses a fluoropolymer hybrid organic/inorganic composite membrane obtainable by using sol-gel technique, which exhibits increased electrolyte retention ability, to be suitably used as a polymer electrolyte membrane in an electrochemical device. WO 2015/169835 (SOLVAY SA and COMMISSARIAT A L'ENERGIE ATOMIQUE ET AUX ENERGIES ALTERNATIVES) further discloses a composite electrode exhibiting high adhesion to metal collectors and high cohesion within the electro-active materials while ensuring high ionic conductivity.

Moreover, US 2018/0123167 (COMMISSARIAT A L'ENERGIE ATOMIQUE ET AUX ENERGIES ALTERNATIVES) proposes a Li-ion battery comprising a positive electrode, a negative electrode and an electrolyte comprising a Li salt, wherein the positive electrode, the negative electrode and the electrolyte all three appear in the form of gels.

Accordingly, it is not obvious for a person skilled in the art to combine at least one gelled electrode with a liquid electrolyte, which requires the presence of a polymeric material as standard separator, to produce an electrochemical device.

It was unexpectedly demonstrated by the present inventors that the association of at least one gelled electrode with a liquid electrolyte and a standard separator makes it possible to produce a flexible/foldable electrochemical device exhibiting high electric capacity. The process according to the present invention also has an advantage in view of the substantially reduced time necessary for filling the electrochemical device as assembled with the liquid electrolyte.

### SUMMARY OF THE INVENTION

A first object of the present invention is an electrochemical device comprising a) a positive electrode, b) a negative electrode, c) a separator, and d) a liquid electrolyte, wherein at least one of said positive electrode and said negative electrode is a gelled electrode comprising an electronic conductive substrate and directly adhered onto the electronic conductive substrate, at least one layer of a gelled electrode-forming composition, and wherein the d) liquid electrolyte comprises at least one organic carbonate and/or at least one ionic liquid, and at least one metal salt.

A second object of the present invention is to provide a process for manufacturing an electrochemical device comprising the steps of:

(I) assembling at least

a) a positive electrode;

b) a negative electrode; and

c) a separator interposed between said positive electrode and said negative electrode,

wherein at least one electrode is a gelled electrode obtained by
providing an electronic conductive substrate;
providing a gelled electrode-forming composition
applying the gelled electrode-forming composition onto the electronic conductive substrate;
optionally drying the electronic conductive substrate coated with the gelled electrode-forming composition; and
calendaring the same into a film having thickness between 80 μm and 900 μm, preferably between 100 μm and 800 μm, and more preferably between 200 μm and 600 μm, and

(II) filling the electrochemical device as assembled with a liquid medium (II) comprising at least one organic carbonate and/or at least one ionic liquid, and optionally at least one metal salt.

In an aspect, the gelled electrode-forming composition according to the present invention comprises;

i) at least one partially fluorinated fluoropolymer comprising
at least one first recurring unit derived from at least one ethylenically unsaturated fluorinated monomer, and
at least one second recurring unit derived from at least one hydrogenated monomer comprising at least one carboxylic group;

ii) at least one electro-active compound;

iii) a liquid medium (I);

iv) optionally, at least one conductive additive; and

v) optionally, at least an organic solvent (S) different from liquid medium (I).

### BRIEF DESCRIPTION OF DRAWINGS

FIG. 1 shows the picture of a prismatic cell of Example 1.

FIG. 2 shows the pictures of the anode (a) and the cathode (b) of the prismatic cell of Example 1 after removal from the assembly and und-wind.

FIG. 3 shows the pictures of the anode (a) and the cathode (b) of the prismatic cell of Comparative Example 1 after removal from the assembly and und-wind.

### DETAILED DESCRIPTION OF THE INVENTION

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups.

As used herein, the terminology “(Cn-Cm)” in reference to an organic group, wherein n and m are integers, respectively, indicates that the group may contain from n carbon atoms to m carbon atoms per group.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

Unless otherwise specified, in the context of the present invention the amount of a component in a composition is indicated as the ratio between the weight of the component and the total weight of the composition multiplied by 100 (i.e., % by weight or wt %).

By the term “electrochemical device”, it is hereby intended to denote an electrochemical cell/assembly comprising a positive electrode, a negative electrode and a liquid electrolyte, wherein a monolayer or multilayer separator is in contact to at least one surface of one of the said electrodes. Non-limitative examples of suitable electrochemical devices include, notably, secondary batteries, especially, alkaline or an alkaline-earth secondary batteries such as lithium ion batteries, lead-acid batteries, and capacitors, especially lithium ion-based capacitors and electric double-layer capacitors (supercapacitors).

The constituents of the electrochemical device according to the present invention are described hereinafter in details. It is to be understood that both the foregoing general description and the following detailed description are exemplary and are intended to provide further explanation of the invention as claimed. Accordingly, various changes and modifications described herein will be apparent to those skilled in the art. Moreover, descriptions of well-known functions and constructions may be omitted for clarity and conciseness.

The present invention provides an electrochemical device comprising a) a positive electrode, b) a negative electrode, c) a separator, and d) a liquid electrolyte, wherein at least one of said positive electrode and said negative electrode is a gelled electrode comprising an electronic conductive substrate and directly adhered onto the electronic conductive substrate, at least one layer of a gelled electrode-forming composition, and wherein the d) liquid electrolyte comprises at least one organic carbonate and/or at least one ionic liquid, and at least one metal salt.

According to the present invention, the combination of at least one of the a) positive electrode and the b) negative electrode, which is in the form of gel, together with a liquid electrolyte and a standard separator makes it possible to produce a flexible/foldable electrochemical device exhibiting highly loaded electrodes with an areal capacity between 1.0 mAh/cm² and 9.0 mAh/cm², preferably between 4.0 mAh/cm² and 7.0 mAh/cm². A gelled electrode presents higher flexibility than a classical electrode, notably with higher loading of electro-active materials without damage to the electrode structure.

Moreover, in view of manufacturing process, the filling time of the electrochemical device once being assembled with a liquid electrolyte can be substantially reduced.

In the present invention, the term “negative electrode” is intended to denote, in particular, the electrode of an electrochemical cell, where oxidation occurs during discharging.

In the present invention, the term “positive electrode” is intended to denote, in particular, the electrode of an electrochemical cell, where reduction occurs during discharging.

For the purpose of the present invention, the term “gelled electrode” is defined below.

In an embodiment, at least one of said positive electrode and said negative electrode according to the present invention has thickness between 80 μm and 900 μm, preferably between 100 μm and 800 μm, and more preferably between 200 μm and 600 μm.

The gelled electrodes used in the electrochemical device of the present invention can thus have a quite high thickness that allows high loading of the electrodes, while retaining homogeneous distribution of active material, partially fluorinated fluoropolymer and conductive substrate. The resulting devices have thus high capacity and are capable of delivering high energy

In the present invention, the term “filling time” is hereby defined as the time needed to inject the liquid medium and ensure proper distribution of the liquid medium within an electrochemical device to completely wet the electrodes and the separator.

In the present invention, the nature of the electronic conductive substrate depends on whether the electrode thereby provided is a positive electrode or a negative electrode. Should the electrode of the invention be a positive electrode, the electronic conductive substrate typically comprises, preferably consists of, carbon (C) or at least one metal selected from the group consisting of Aluminium (AI), Nickel (Ni), Titanium (Ti), and alloys thereof, preferably Al. Should the electrode of the invention be a negative electrode, the electronic conductive substrate typically comprises, preferably consists of, Carbon (C) or Silicon (Si) or at least one metal selected from the group consisting of Lithium (Li), Sodium (Na), Zinc (Zn), Magnesium (Mg), Copper (Cu) and alloys thereof, preferably Cu.

By the term “separator”, it is hereby intended to denote a monolayer or multilayer polymeric or ceramic material/film, which electrically and physically separates the electrodes of opposite polarities in an electrochemical device and is permeable to ions flowing between them.

In the present invention, the separator can be any porous substrate commonly used for a separator in an electrochemical device.

In one embodiment, the separator is a porous polymeric material comprising at least one material selected from the group consisting of polyester such as polyethylene terephthalate and polybutylene terephthalate, polyphenylene sulphide, polyacetal, polyamide, polycarbonate, polyimide, polyether sulfone, polyphenylene oxide, polyphenylene sulfide, polyethylene naphthalene, polyethylene oxide, polyacrylonitrile, polyolefin such as polyethylene and polypropylene, or mixtures thereof.

In a particular embodiment, the separator is a porous polymeric material coated with PVDF or inorganic nanoparticles, for instance, SiO₂, TiO₂, Al₂O₃, ZrO₂, etc.

In the present invention, the term “liquid medium” is intended to denote a medium comprising one or more substances in the liquid state at 20° C. under atmospheric pressure. In the present invention, the term “liquid medium (I)” is intended to denote a liquid medium comprised within a gelled electrode-forming composition.

In the present invention, the term “liquid medium (II)” is intended to denote a liquid medium which is added at the filling stage. The liquid medium (II) is then present and distributed in the whole electrochemical device.

In the present invention, the term “liquid medium” is intended to correspond to either a liquid medium (I) or a liquid medium (II).

In the present invention, a liquid electrolyte comprises a mixture of a liquid medium (I) and a liquid medium (II).

In the present invention, the liquid medium (I) and the liquid medium (II) is identical or different.

In the present invention, the liquid medium (I) and the liquid medium (II) respectively comprise at least one organic carbonate and/or at least one ionic liquid.

In the present invention, at least one of the liquid medium (I) and the liquid medium (II) additionally comprise at least one metal salt.

In one embodiment, a separator and a liquid medium (II) comprising at least one organic carbonate and/or at least one ionic liquid is placed between the a) positive electrode and the b) negative electrode.

In the present invention, the choice of the organic carbonate or the ionic liquid is not particularly limited provided that it is suitable for solubilising the metal salt.

In one embodiment, the metal salt is selected from the group consisting of:

(a) MeI, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(SO₂F)₂]ₙ, Me[N(CF₃SO₂)₂]ₙ, Me[N(C₂F₅SO₂)₂]ₙ, Me[N(CF₃SO₂)(R_{F}SO₂)]ₙ, wherein R_{F} is C₂F₅, C₄F₉ or CF₃OCF₂CF₂, Me(AsF₆)ₙ, Me[C(CF₃SO₂)₃]ₙ, Me₂Sₙ, wherein Me is a metal, preferably a transition metal, an alkaline metal or an alkaline-earth metal, more preferably Me being Li, Na, K or Cs, even more preferably Me being Li, and n is the valence of said metal, typically n being 1 or 2;

(b)

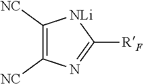

wherein R′_{F} is selected from the group consisting of F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ and CF₂OCF₃; and

(c) combinations thereof.

In one embodiment, the organic carbonate is partially or fully fluorinated carbonate compound. The organic carbonate compound according to the present invention may be either cyclic carbonate or acyclic carbonate.

Non-limiting examples of the organic carbonate compound include, notably, ethylene carbonate (1,3-dioxolan-2-one), propylene carbonate, vinylene carbonate (1,3-dioxol-2-one), 4-methylene-1,3-dioxolan-2-one, 4,5-dimethylene-1,3-dioxolan-2-one, dimethyl carbonate, diethyl carbonate, ethyl methyl carbonate, dipropyl carbonate, methyl propyl carbonate, methyl butyl carbonate, ethyl butyl carbonate, propyl butyl carbonate, dibutyl carbonate, di-tert-butyl carbonate and butylene carbonate.

The fluorinated carbonate compound may be mono-fluorinated or polyfluorinated. Suitable examples of the fluorinated carbonate compound comprises, but not limited to, mono-fluorinated ethylene carbonate (4-fluoro-1,3-dioxolan-2-one) and difluorinated ethylene carbonate, mono- and difluorinated propylene carbonate, mono- and difluorinated butylene carbonate, 3,3,3-trifluoropropylene carbonate, fluorinated dimethyl carbonate, fluorinated diethyl carbonate, fluorinated ethyl methyl carbonate, fluorinated dipropyl carbonate, fluorinated dibutyl carbonate, fluorinated methyl propyl carbonate, and fluorinated ethyl propyl carbonate.

In a preferred embodiment, the organic carbonates chosen are mixture of ethylene carbonate and propylene carbonate.

In another preferred embodiment, the organic carbonates chosen are a mixture of ethylene carbonate, propylene carbonate and vinylene carbonate.

In another embodiment, the liquid medium further comprises at least one sulfone compound in addition to the organic carbonate. The sulfone compound according to the present invention may be either cyclic sulfone or acyclic sulfone.

Non-limiting examples of the sulfone compound include, notably, tetramethylene sulfone (sulfolane), butadiene sulfone (sulfolene), pentamethylene sulfone, hexamethylene sulfone, thiazolidine 1,1-dioxide, thiomorpholine 1,1-dioxide, dimethyl sulfone, diethyl sulfone, ethyl methyl sulfone, and mixtures thereof.

In a preferred embodiment, the liquid medium comprises a mixture of ethylene carbonate, propylene carbonate, vinylene carbonate and sulfolane.

In a preferred embodiment, the liquid medium (II) is a mixture of organic carbonate compounds which may wet optimally the separator. In a more preferred embodiment, the mixture of organic carbonate compounds comprises cyclic carbonate and/or acyclic carbonate. Non-limiting examples of the organic carbonate compounds include, notably, ethylene carbonate (1,3-dioxolan-2-one), propylene carbonate, vinylene carbonate (1,3-dioxol-2-one), 4-methylene-1,3-dioxolan-2-one, 4,5-dimethylene-1,3-dioxolan-2-one, dimethyl carbonate, diethyl carbonate, ethyl methyl carbonate, dipropyl carbonate, methyl propyl carbonate, methyl butyl carbonate, ethyl butyl carbonate, propyl butyl carbonate, dibutyl carbonate, di-tert-butyl carbonate and butylene carbonate.

The term “ionic liquid” as used herein refers to a compound comprising a positively charged cation and a negatively charged anion, which is in the liquid state at temperature of 100° C. or less under atmospheric pressure. While ordinary liquids such as water are predominantly made of electrically neutral molecules, ionic liquids are largely made of ions and short-lived ion pairs. As used herein, the term “ionic liquid” indicates a compound free from solvent.

The term “cationic atom” as used herein refers to at least one non-metal atom which carries the positive charge.

The term “onium cation” as used herein refers to a positively charged ion having at least part of its charge localized on at least one non-metal atom such as O, N, S, or P.

In the present invention, the ionic liquid has a general formula of Aⁿ⁻ Q^{l+}_{(n/l)}, wherein
Aⁿ⁻ represents an anion;
Q^{l+}_{(n/l)} represents a cation;
n and l, independently selected between 1 and 5, represent respectively the charges of the anion Aⁿ⁻ and of the cation Q^{l+}_{(n/l)}.

The cation(s) may be selected, independently of one another, from metal cations and organic cations. The cation(s) may be mono-charged cations or polycharged cations.

As metal cation, mention may preferably be made of alkali metal cations, alkaline-earth metal cations and cations of d-block elements.

In the present invention, Q^{l+}(n/i) may represent an onium cation. Onium cations are cations formed by the elements of Groups VB and VIB (as defined by the old European IUPAC system according to the Periodic Table of the Elements) with three or four hydrocarbon chains. The Group VB comprises the N, P, As, Sb and Bi atoms. The Group VIB comprises the O, S, Se, Te and Po atoms. The onium cation can in particular be a cation formed by an atom selected from the group consisting of N, P, O and S, more preferably N and P, with three or four hydrocarbon chains.

The onium cation Q^{l+}_{(n/l)} can be selected from:
heterocyclic onium cations; in particular those selected from the group consisting of:

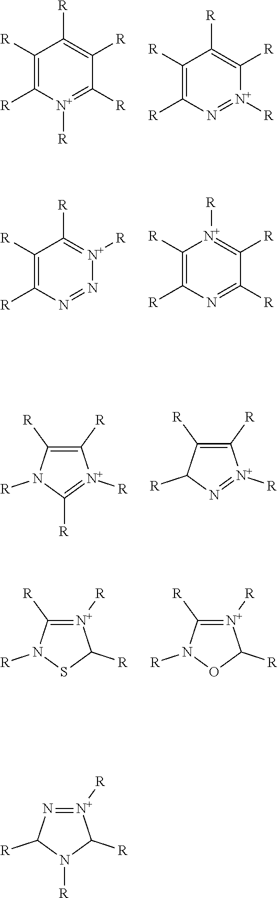

unsaturated cyclic onium cations; in particular those selected from the group consisting of:

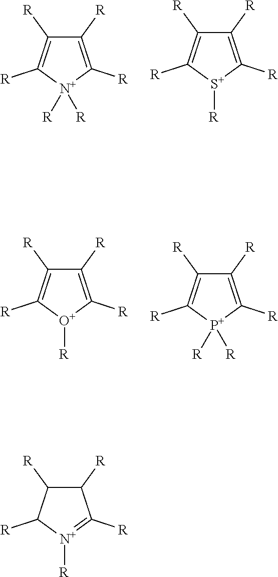

saturated cyclic onium cations; in particular those selected from the group consisting of:

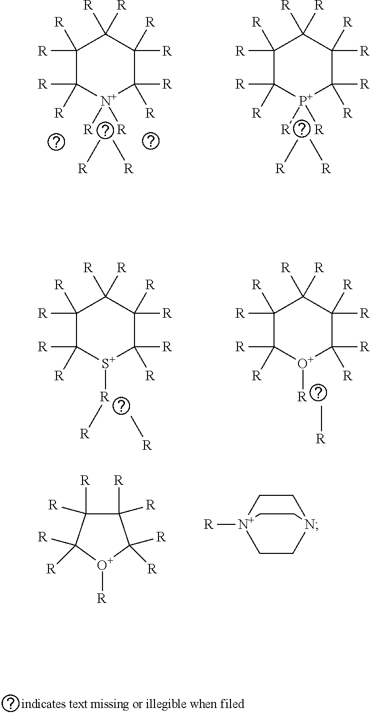

and
non-cyclic onium cations; in particular those of general formula ⁺L-R′ₛ, in which L represents an atom selected from the group consisting of N, P, O and S, more preferably N and P, s represents the number of R′ groups selected from 2, 3 or 4 according to the valence of the element L, each R′ independently represents a hydrogen atom or a C₁ to C₈ alkyl group, and the bond between L⁺ and R′ can be a single bond or a double bond.

In the above formulas, each “R” symbol represents, independently of one another, a hydrogen atom or an organic group. Preferably, each “R” symbol can represent, in the above formulas, independently of one another, a hydrogen atom or a saturated or unsaturated and linear, branched or cyclic C₁ to C₁₈ hydrocarbon group optionally substituted one or more times by a halogen atom, an amino group, an imino group, an amide group, an ether group, an ester group, a hydroxyl group, a carboxyl group, a carbamoyl group, a cyano group, a sulfone group or a sulfite group.

The cation Q^{l+}_{(n/l)} can more particularly be selected from ammonium, phosphonium, pyridinium, pyrrolidinium, pyrazolinium, imidazolium, arsenium, quaternary phosphonium and quaternary ammonium cations.

The quaternary phosphonium or quaternary ammonium cations can more preferably be selected from tetraalkylammonium or tetraalkylphosphonium cations, trialkylbenzylammonium or trialkylbenzylphosphonium cations or tetraarylammonium or tetraarylphosphonium cations, the alkyl groups of which, either identical or different, represents a linear or branched alkyl chain having from 4 to 12 carbon atoms, preferably from 4 to 6 carbon atoms, and the aryl groups of which, either identical or different, represents a phenyl or naphthyl group.

In a specific embodiment, Q^{l+}_{(n/l)} represents a quaternary phosphonium or quaternary ammonium cation.

In one preferred embodiment, Q^{l+}_{(n/l)} represents a quaternary phosphonium cation. Non-limiting examples of the quaternary phosphonium cation comprise trihexyl(tetradecyl)phosphonium, and a tetraalkylphosphonium cation, particularly the tetrabutylphosphonium (PBu₄) cation.

In another embodiment, Q^{l+}_{(n/l)} represents an imidazolium cation. Non-limiting examples of the imidazolium cation comprise 1,3-dimethylimidazolium, 1-(4-sulfobutyl)-3-methyl imidazolium, 1-allyl-3H-imidazolium, 1-butyl-3-methylimidazolium, 1-ethyl-3-methylimidazolium, 1-hexyl-3-methylimidazolium, 1-octyl-3-methylimidazolium

In another embodiment, Q^{l+}_{(n/l)} represents a quaternary ammonium cation which is selected in particular from the group consisting of tetraethylammonium, tetrapropylammonium, tetrabutylammonium, trimethylbenzylammonium, methyltributylammonium, N,N-diethyl-N-methyl-N-(2-methoxyethyl) ammonium, N,N-dimethyl-N-ethyl-N-(3-methoxypropyl) ammonium, N,N-dimethyl-N-ethyl-N-benzyl ammonium, N, N-dimethyl-N-ethyl-N-phenylethyl ammonium, N-tributyl-N-methyl ammonium, N-trimethyl-N-butyl ammonium, N-trimethyl-N-hexyl ammonium, N-trimethyl-N-propyl ammonium, and Aliquat 336 (mixture of methyltri(C₈ to C₁₀ alkyl)ammonium compounds).

In one embodiment, Q^{l+}_{(n/l)} represents a piperidinium cation, in particular N-butyl-N-methyl piperidinium, N-propyl-N-methyl piperidinium.

In another embodiment, Q^{l+}_{(n/l)} represents a pyridinium cation, in particular N-methylpyridinium.

In a more preferred embodiment, Q^{l+}_{(n/l)} represents a pyrrolidinium cation. Among specific pyrrolidinium cations, mention may be made of the following: C₁₋₁₂alkyl-C₁₋₁₂alkyl-pyrrolidinium, and more preferably C₁₋₄alkyl-C₁₋₄alkyl-pyrrolidinium. Examples of pyrrolidinium cations comprise, but not limited to, N,N-dimethylpyrrolidinium, N-ethyl-N-methylpyrrolidinium, N-isopropyl-N-methylpyrrolidinium, N-methyl-N-propylpyrrolidinium, N-butyl-N-methylpyrrolidinium, N-octyl-N-methylpyrrolidinium, N-benzyl-N-methylpyrrolidinium, N-cyclohexylmethyl-N-methylpyrrolidinium, N-[(2-hydroxy)ethyl]-N-methylpyrrolidinium. More preferred are N-methyl-N-propylpyrrolidinium (PYR13) and N-butyl-N-methylpyrrolidinium (PYR14).

Non-limiting examples of an anion of the ionic liquid comprise iodide, bromide, chloride, hydrogen sulfate, dicyanamide, acetate, diethyl phosphate, methyl phosphonate, fluorinated anion, e.g.,

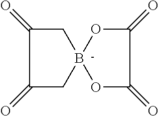

hexafluorophosphate (PF₆⁻) and tetrafluoroborate (BF₄⁻), and oxaloborate of the following formula:

In one embodiment, Aⁿ⁻ is a fluorinated anion. Among the fluorinated anions that can be used in the present invention, fluorinated sulfonimide anions may be particularly advantageous. The organic anion may in particular be selected from the anions having the following general formula:

(Eₐ-SO₂)N⁻R

in which:
Eₐ represents a fluorine atom or a group having preferably from 1 to 10 carbon atoms, selected from fluoroalkyls, perfluoroalkyls and fluoroalkenyls, and
R represents a substituent.

Preferably, Eₐ may represent F or CF₃.

According to a first embodiment, R represents a hydrogen atom.

According to a second embodiment, R represents a linear or branched, cyclic or non-cyclic hydrocarbon-based group, preferably having from 1 to 10 carbon atoms, which can optionally bear one or more unsaturations, and which is optionally substituted one or more times with a halogen atom, a nitrile function, or an alkyl group optionally substituted one of several time by a halogen atom. Moreover, R may represent a nitrile group —CN.

According to a third embodiment, R represents a sulfinate group. In particular, R may represent the group —SO₂-Eₐ, Eₐ being as defined above. In this case, the fluorinated anion may be symmetrical, i.e. such that the two Eₐ groups of the anion are identical, or non-symmetrical, i.e. such that the two Eₐ groups of the anion are different.

Moreover, R may represent the group —SO₂—R′, R′ representing a linear or branched, cyclic or non-cyclic hydrocarbon-based group, preferably having from 1 to 10 carbon atoms, which can optionally bear one or more unsaturations, and which is optionally substituted one or more times with a halogen atom, a nitrile function, or an alkyl group optionally substituted one of several time by a halogen atom. In particular, R′ may comprise a vinyl or allyl group. Furthermore, R may represent the group —SO₂—N—R′, R′ being as defined above or else R′ represents a sulfonate function —SO₃.

Cyclic hydrocarbon-based group may preferably refer to a cycloalkyl group or to an aryl group. “Cycloalkyl” refers to a monocyclic hydrocarbon chain, having 3 to 8 carbon atoms. Preferred examples of cycloalkyl groups are cyclopentyl and cyclohexyl. “Aryl” refers to a monocyclic or polycyclic aromatic hydrocarbon group, having 6 to 20 carbon atoms. Preferred examples of aryl groups are phenyl and naphthyl. When the group is a polycyclic group, the rings may be condensed or attached by a (sigma) bonds.

According to a fourth embodiment, R represents a carbonyl group. R may in particular be represented by the formula —CO—R′, R′ being as defined above.

The organic anion that can be used in the present invention may advantageously be selected from the group consisting of CF₃SO₂N⁻ SO₂CF₃ (bis(trifluoromethane sulfonyl)imide anion, commonly denoted as TFSI), FSO₂N⁻SO₂F (bis(fluorosulfonyl)imide anion, commonly denoted as FSI), CF₃SO₂N⁻SO₂F, and CF₃SO₂N⁻SO₂N—SO₂CF₃.

In a preferred embodiment, the ionic liquid contains:
a positively charged cation selected from the group consisting of imidazolnium, pyridinium, pyrrolidinium and piperidinium ions optionally containing one or more C₁-C₃₀ alkyl groups, and
a negatively charged anion selected from the group consisting of halides, fluorinated anions and borates.

Non-limiting examples of C₁-C₃₀ alkyl groups include, notably, methyl, ethyl, propyl, iso-propyl, n-butyl, isobutyl, sec-butyl, t-butyl, pentyl, isopentyl, 2,2-dimethyl-propyl, hexyl, 2,3-dimethyl-2-butyl, heptyl, 2,2-dimethyl-3-pentyl, 2-methyl-2-hexyl, octyl, 4-methyl-3-heptyl, nonyl, decyl, undecyl and dodecyl groups.

In one embodiment, the gelled electrode comprises an electronic conductive substrate and directly adhered onto the electronic conductive substrate, at least one layer of a gelled electrode-forming composition comprising:

i) at least one partially fluorinated fluoropolymer comprising
at least one first recurring unit derived from at least one ethylenically unsaturated fluorinated monomer, and
at least one second recurring unit derived from at least one hydrogenated monomer comprising at least one carboxylic group;

ii) at least one electro-active compound;

iii) a liquid medium (I) comprising at least one organic carbonate and/or at least one ionic liquid, and optionally at least one metal salt;

iv) optionally, at least one conductive additive, and

v) optionally, at least one organic solvent (S) different from the liquid medium (I).

For the purpose of the present invention, the term “electro-active compound” is intended to denote a compound which is able to incorporate or insert into its structure and substantially release therefrom alkaline or alkaline-earth metal ions during the charging phase and the discharging phase of an electrochemical device. The electro-active compound is preferably able to incorporate or insert and release lithium ions.

The nature of the electro-active compound depends on whether the electrode thereby provided is a positive electrode or a negative electrode.

In the case of forming a positive electrode for a Li-ion secondary battery, the electro-active compound is not particularly limited. It may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1), and spinel-structured LiMn₂O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂.

As an alternative, still in the case of forming a positive electrode for a Li-ion secondary battery, the electro-active compound may comprise a lithiated or partially lithiated transition metal oxyanion-based electro-active material of formula M₁M₂(JO₄)_{f}E_{1-f,} wherein M₁ is lithium, which may be partially substituted by another alkali metal representing less that 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electro-active compound has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electro-active compound is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative electrode for a lithium secondary battery, the electro-active compound may preferably comprise:
graphite carbons able to intercalate lithium, typically existing in forms of such as powders, flakes, fibers or spheres (for example, meso-carbon microbeads) hosting lithium;
lithium metal;
lithium alloy compositions, including notably those described in U.S. Pat. No. 6,203,944 (3M Innovative Properties Co.);
lithium titanates, generally represented by formula Li₄Ti₅O₁₂; these compounds are generally considered as “zero-strain” insertion materials, having low level of physical expansion upon taking up the mobile ions, i.e. Li⁺;
lithium-silicon alloys, generally known as lithium silicides with high Li/Si ratios, in particular lithium silicides of formula Li_{4.4}Si;
composite materials based on carbonaceous material with silicon and/or silicon oxide, notably graphite carbon/silicon and graphite/silicon oxide, wherein the graphite carbon is composed of one or several carbons able to intercalate lithium;
lithium-germanium alloys, including crystalline phases of formula Li_{4.4}Ge.

In one preferred embodiment, the electro-active compound for a positive electrode is LiNi_{1/3}Mn_{1/3}Co_{1/3}O₂, LiNi_{0.6}Mn_{0.2}Co_{0.2}O₂ or LiNi_{0.8}CO_{0.15}Al_{0.05}O₂.

In another preferred embodiment, the electro-active compound for a negative electrode is graphite carbon or graphite carbon/silicon.

In one embodiment, the ii) at least one electro-active compound according to the present invention is loaded onto the electronic conductive substrate to have an areal capacity between 1.0 mAh/cm² and 9.0 mAh/cm², preferably between 4.0 mAh/cm² and 7.0 mAh/cm².

In one preferred embodiment, the electrochemical device according to the present invention comprises a gelled positive electrode and lithium metal as a negative electrode.

In another preferred embodiment, the electrochemical device according to the present invention comprises a gelled positive electrode and a gelled negative electrode.

For the purpose of the present invention, the term “partially fluorinated fluoropolymer” is intended to denote a polymer comprising at least one first recurring unit derived from at least one ethylenically unsaturated fluorinated monomer and at least one second recurring unit derived from at least one hydrogenated monomer, wherein at least one of said ethylenically unsaturated fluorinated monomer and said hydrogenated monomer comprises at least one hydrogen atom.

By the term “fluorinated monomer” it is hereby intended to denote an ethylenically unsaturated monomer comprising at least one fluorine atom.

By the term “hydrogenated monomer” it is hereby intended to denote an ethylenically unsaturated monomer comprising at least one hydrogen atom and free from fluorine atoms.

The term “at least one fluorinated monomer” is understood to mean that the partially fluorinated fluoropolymer may comprise recurring units derived from one or more than one fluorinated monomers. In the present invention, the expression “fluorinated monomers” is understood to be, for the purposes of the present invention, both plural and singular, that is to say that they denote one or more than one fluorinated monomers as defined above.

The term “at least one hydrogenated monomer” is understood to mean that the polymer may comprise recurring units derived from one or more than one hydrogenated monomers. In the present invention, the expression “hydrogenated monomers” is understood, for the purposes of the present invention, to be plural and singular, that is to say that they denote one or more than one hydrogenated monomers as defined above.

The partially fluorinated fluoropolymer typically comprises at least one first recurring unit derived from at least one ethylenically unsaturated fluorinated monomer, at least one second recurring unit derived from at least one hydrogenated monomer comprising at least one carboxylic group and, optionally a third recurring unit derived from at least one fluorinated monomer different from the first recurring unit.

The partially fluorinated fluoropolymer is typically obtainable by polymerization of at least one fluorinated monomer, at least one hydrogenated monomer comprising at least one carboxylic group and, optionally, at least one fluorinated monomer different from said fluorinated monomer.

Should the fluorinated monomer comprise at least one hydrogen atom, it is designated as hydrogen-containing fluorinated monomer.

Should the fluorinated monomer be free of hydrogen atoms, it is designated as per(halo)fluorinated monomer.

The fluorinated monomer may further comprise one or more other halogen atoms (Cl, Br, I).

Non-limiting examples of suitable fluorinated monomers include, notably, the followings:
C₂-C₈ perfluoroolefins such as tetrafluoroethylene and hexafluoropropylene;
C₂-C₈ hydrogenated fluoroolefins such as vinylidene fluoride, vinyl fluoride, 1,2-difluoroethylene and trifluoroethylene;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins such as chlorotrifluoroethylene;
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form; and
fluorodioxoles, preferably perfluorodioxoles.

Should the fluorinated monomer be a hydrogen-containing fluorinated monomer such as, for instance, vinylidene fluoride, trifluoroethylene or vinyl fluoride, the partially fluorinated fluoropolymer is either a partially fluorinated fluoropolymer comprising recurring units derived from at least one hydrogen-containing fluorinated monomer, at least one hydrogenated monomer comprising at least one carboxylic group and, optionally at least one fluorinated monomer different from said hydrogen-containing fluorinated monomer.

Should the fluorinated monomer be a per(halo)fluorinated monomer such as, for instance, tetrafluoroethylene, chlorotrifluoroethylene, hexafluoropropylene or a perfluoroalkylvinylether, the partially fluorinated fluoropolymer is a partially fluorinated fluoropolymer comprising recurring units derived from at least one per(halo)fluorinated monomer, at least one hydrogenated monomer comprising at least one carboxylic group and, optionally at least one fluorinated monomer different from said per(halo)fluorinated monomer.

The partially fluorinated fluoropolymer may be amorphous or semi-crystalline.

The term “amorphous” is hereby intended to denote a polymer having a heat of fusion of less than 5 J/g, preferably of less than 3 J/g, more preferably of less than 2 J/g, as measured according to ASTM D3418-08.

The term “semi-crystalline” is hereby intended to denote a polymer having a heat of fusion of from 10 to 90 J/g, preferably of from 30 to 60 J/g, more preferably of from 35 to 55 J/g, as measured according to ASTM D3418-08.

The partially fluorinated fluoropolymer is preferably semi-crystalline.

The partially fluorinated fluoropolymer comprises preferably at least 0.01% by moles, more preferably at least 0.05% by moles, even more preferably at least 0.1% by moles of at least one second recurring unit derived from at least one hydrogenated monomer comprising at least one carboxylic group.

The partially fluorinated fluoropolymer comprises preferably at most 20% by moles, more preferably at most 15% by moles, even more preferably at most 10% by moles, most preferably at most 3% by moles of at least one second recurring units derived from at least one hydrogenated monomer comprising at least one carboxylic group.

Determination of average mole percentage of at least once second recurring unit derived from at least one hydrogenated monomer comprising at least one carboxylic group in the partially fluorinated fluoropolymer can be performed by any suitable method. Mention can be notably made of acid-base titration methods or NMR methods.

The partially fluorinated fluoropolymer is preferably a partially fluorinated fluoropolymer comprising recurring units derived from vinylidene fluoride (VDF), at least one hydrogenated monomer comprising at least one carboxylic group and, optionally, at least one fluorinated monomer different from VDF.

In a preferred embodiment, the partially fluorinated fluoropolymer preferably comprises recurring units derived from:
at least 60% by moles, preferably at least 75% by moles, more preferably at least 85% by moles of vinylidene fluoride (VDF),
from 0.01% to 20% by moles, preferably from 0.05% to 15% by moles, more preferably from 0.1% to 10% by moles of at least one hydrogenated monomer comprising at least one carboxylic group, and
optionally, from 0.1% to 15% by moles, preferably from 0.1% to 12% by moles, more preferably from 0.1% to 10% by moles of at least one fluorinated monomer selected from vinyl fluoride, chlorotrifluoroethylene (CTFE), hexafluoropropylene (HFP), tetrafluoroethylene (TFE), trifluoroethylene and perfluoromethylvinylether (PMVE).

In another preferred embodiment, an amount of the partially fluorinated fluoropolymer is from 3.0 to 50.0 wt %, preferably from 5.0 to 40 wt %, and more preferably from 7.0 to 35.0 wt % based on the total weight of a liquid medium (I) within a gelled electrode-forming composition of the present invention.

In one embodiment, the intrinsic viscosity of the partially fluorinated fluoropolymer is lower than 0.70 l/g, preferably lower than 0.60 l/g, and more preferably lower than 0.50 l/g.

In another embodiment, the intrinsic viscosity of the partially fluorinated fluoropolymer is higher than 0.15 l/g, preferably higher than 0.20 l/g, and more preferably higher than 0.25 l/g.

In the present invention, the intrinsic viscosity is measured using the following equation at 25° C. on the basis of dropping time of a solution obtained by dissolving the polymer in N,N-dimethylformamide at a concentration of about 0.2 g/dl using Ubbelohde viscometer at 25° C.

$$[ η ] = \frac{{η}_{sp} + Γ \cdot ln {η}_{r}}{( 1 + Γ ) \cdot c} \qquad [ Equation ]$$

where c is polymer concentration [g/l], ηᵣ is the relative viscosity, i.e. the ratio between the dropping time of sample solution and the dropping time of solvent, ηₛₚ is the specific viscosity, i.e. ηᵣ−1, and Γ is an experimental factor, which for the polymer corresponds to 3.

The hydrogenated monomer comprising at least one carboxylic group is preferably selected from the group consisting of (meth)acrylic monomers of formula (I):

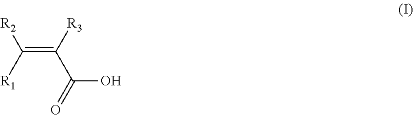

wherein each of R₁, R₂ and R₃, equal to or different from each other, is independently a hydrogen atom or a C₁-C₃ hydrocarbon group.

Non-limiting examples of hydrogenated monomers comprising at least one carboxylic group include, notably, acrylic acid and methacrylic acid.

The partially fluorinated fluoropolymer is advantageously a linear polymer comprising linear sequences of a first recurring unit derived from at least one fluorinated monomer, a second recurring unit derived from at least one hydrogenated monomer comprising at least one carboxylic group and, optionally a third recurring unit derived from at least one fluorinated monomer different from the first recurring unit.

The partially fluorinated fluoropolymer is thus typically distinguishable from graft polymers.

The partially fluorinated fluoropolymer is advantageously a random polymer comprising linear sequences of randomly distributed recurring units, that is, a first recurring unit derived from at least one fluorinated monomer, a second recurring unit derived from at least one hydrogenated monomer comprising at least one carboxylic group and, optionally a third recurring unit derived from at least one fluorinated monomer different from the first recurring unit.

The expression “randomly distributed recurring units” is intended to denote the percent ratio between the average numbers of sequences of at least one hydrogenated monomers (%), said sequences being comprised between two recurring units derived from at least one fluorinated monomer, and the total average number of recurring units derived from at least one hydrogenated monomer (%).

When each of the recurring units derived from at least one hydrogenated monomer is isolated, that is to say that a recurring unit derived from a hydrogenated monomer is comprised between two recurring units of at least one fluorinated monomer, the average number of sequences of at least one hydrogenated monomer equals the average total number of recurring units derived from at least one hydrogenated monomer, so that the fraction of randomly distributed recurring units derived from at least one functional hydrogenated monomer is 100%: this value corresponds to a perfectly random distribution of recurring units derived from at least one hydrogenated monomer. Thus, the larger is the number of isolated recurring units derived from at least one hydrogenated monomer with respect to the total number of recurring units derived from at least one functional hydrogenated monomer, the higher will be the percentage value of fraction of randomly distributed recurring units derived from at least one hydrogenated monomer.

The partially fluorinated fluoropolymer is thus typically distinguishable from block polymers.

In the present invention, the term “conductive additive” is intended to denote a material which is used to ensure the electrodes has good charging and discharging performance. Non-limiting examples of suitable conductive additives include carbon black, acetylene black, carbon fibers, carbon nanotubes and Ketjen black. Suitable conductive carbons include acetylene black. A commercially available carbon black is Super P® available from Alfa Aesar. Depending on the characteristics of the conductive additive, the conductive additive is preferably present in an amount of 1 to 10 wt % based on the total weight of the electrode-forming composition. The conductive additive is more preferably present in an average amount of 5 wt % or less based on the total weight of the electrode-forming composition.

In one embodiment, the electrode-forming composition of the present invention comprises at least one conductive agent, preferably carbon black.

In the present invention, the choice of the organic solvent (S) is not particularly limited provided that it is suitable for solubilising the partially fluorinated fluoropolymer of the invention.

The organic solvent (S) is typically selected from the group consisting of:
alcohols such as methyl alcohol, ethyl alcohol and diacetone alcohol;
ketones such as acetone, methylethylketone, methylisobutyl ketone, diisobutylketone, cyclohexanone and isophorone;
linear or cyclic esters such as isopropyl acetate, n-butyl acetate, methyl acetoacetate, dimethyl phthalate and γ-butyrolactone;
linear or cyclic amides such as N,N-diethylacetamide, N,N-dimethylacetamide, dimethylformamide and N-methyl-2-pyrrolidone, and
dimethyl sulfoxide.

A second object of the present invention is a process for manufacturing an electrochemical device comprising the steps of:

(I) assembling at least

a) a positive electrode;

b) a negative electrode; and

c) a separator interposed between said positive electrode and said negative electrode,

wherein at least one electrode is a gelled electrode obtained by
providing an electronic conductive substrate;
providing a gelled electrode-forming composition;
applying the gelled electrode-forming composition onto the electronic conductive substrate;
optionally, drying the electronic conductive substrate coated with the gelled electrode-forming composition; and
calendaring the same into a film having thickness between 80 μm and 900 μm, preferably between 100 μm and 800 μm, and more preferably between 200 μm and 600 μm.

(II) filling the electrochemical device as assembled with a liquid medium (II) comprising at least one organic carbonate and/or at least one ionic liquid, and optionally at least one metal salt.

In the present invention, the optional step of drying the electronic conductive substrate coated with the gelled electrode-forming composition is intended to evaporate the organic solvent (S).

In one embodiment, the gelled electrode-forming composition of the present invention comprises

i) at least one partially fluorinated fluoropolymer comprising
at least one first recurring unit derived from at least one ethylenically unsaturated fluorinated monomer,
at least one second recurring unit derived from at least one hydrogenated monomer comprising at least one carboxylic group, and
optionally at least one third recurring unit derived from at least one fluorinated monomer different from the first recurring unit;

ii) at least one electro-active material;

iii) a liquid medium (I) comprising at least one organic carbonate and/or at least one ionic liquid, and optionally at least one metal salt, and

iv) optionally, at least one conductive additive.

v) optionally, at least one organic solvent (S) different from liquid medium (I).

In one embodiment, at least one first recurring unit is derived from vinylidene fluoride (VDF), chlorotrifluoroethylene (CTFE), hexafluoropropylene (HFP), tetrafluoroethylene (TFE), trifluoroethylene, and combinations thereof, and preferably from VDF.

In a preferred embodiment, the at least one first recurring unit derived from at least one ethylenically unsaturated fluorinated monomer is VDF.

In one embodiment, the step of applying the electrode-forming composition onto the electronic conductive substrate is implemented by any suitable procedures such as casting, printing, roll coating, extrusion and co-lamination.

In a specific embodiment, the step of applying the electrode-forming composition onto the electronic conductive substrate. is implemented at temperature between 5° C. and 100° C., preferably between 10° C. and 80° C. and more preferably between 15° C. and 70° C.

Another objective of the present invention is to provide an electrochemical device comprising:
a gelled positive electrode comprising an electronic conductive substrate and directly adhered onto the electronic conductive substrate, at least one layer of the gelled electrode-forming composition of the present invention;
a negative electrode;
a porous polymeric material as a separator interposed between said positive electrode and said negative electrode, which is selected from the group consisting of polyethylene, polypropylene, polytetrafluoroethylene, polyvinyl chloride and combinations thereof, and
a liquid electrolyte being a mixture of a liquid medium (I) and a liquid medium (II),

wherein the liquid medium (I) and the liquid medium (II) are identical or different; wherein the liquid medium (I) and the liquid medium (II) respectively comprise at least one organic carbonate and/or at least one ionic liquid, and wherein at least one of the liquid medium (I) and the liquid medium (II) additionally comprise at least one metal salt.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL PART

Raw Materials

Polymer (FF-A): VDF-AA (0.9% by moles)-HFP (2.4% by moles) polymer having a viscosity of 0.30 l/g in DMF at 25° C.
Polymer (FF-B): VDF-AA (0.9% by moles) polymer having a viscosity of 0.30 l/g in DMF at 25° C.
Liquid Medium-A (II): LP10: 1M LiPF₆ EC:PC:DMC (1:1:3), 2% VC; (wherein EC is ethylene carbonate, PC is propylene carbonate, DMC is dimethyl carbonate and VC is vinylene carbonate).

### Liquid Medium-B (1): LiPF₆ 1M in EC:PC (1:1)+2% VC.

### Graphite-A: 75% Graphite SMG-N-HE1 (Hitachi Chemical Co., Ltd)/25% TIMREX® SFG 6.

### Graphite-B: 75% Graphite SMG-N-HE2 (Hitachi Chemical Co., Ltd)/25% TIMREX® SFG 6.

Carbon Black: C-NERGY® SUPER C65 and VGCF® carbon fiber (CF).

### Active Material: NMC 622.

### Example 1: Preparation of a Prismatic Cell

Anode Composition and Preparation:

A solution of polymer (FF-A) in MEK (Methyl-ethyl Ketone) was prepared at 38° C. and then brought to 19° C. Then, Graphite-B was added to the solution so obtained in a weight ratio of 95/5 (Graphite-B/polymer (FF-A)). Then the liquid medium-B (I) was added to the solution. The weight ratio [m_{electrolyte}/(m_{electrolyte}+m_{polymer (FF-A)})]×100 was 80%.

The solution mixture was then spread with a constant thickness onto a copper current collector foil using a machine roll to roll. The thickness was controlled by the distance between the knife and the metal collector. The solvent was then evaporated at 60° C. from said mixture thereby providing the electrode. The final thickness of the anode electrode was 242 microns. The electrode was calendared obtaining finally 5.51 mAh/cm² and 35.7% of porosity.

Cathode Composition and Preparation:

A solution of polymer (FF-A) in acetone was prepared at 19° C. Then the carbon black and the active material was added to the solution in the following weights ratios: NMC 622 93 wt %; C65 2 wt %, VGCF 1 wt % and polymer (FF-A) 4 wt %. Then the liquid medium-B (I) was added to the solution. The weight ratio [m_{electrolyte}/(m_{electrolyte}+m_{polymer (FF-A)})]×100 was 75.2%.

The solution mixture was then spread with a constant thickness onto a metal collector (aluminium foil) using a roll to roll machine. The thickness was controlled by the distance between the knife and the metal collector. The solvent was then evaporated from said mixture thereby providing the electrode. The final thickness of the anode electrode was 248 microns. The electrode was calendared obtaining finally 5.0 mAh/cm² and 33.2% of porosity.

Manufacture of the Li-Ion Battery Prismatic Cell:

Between the cathode and anode according to the invention a separator Celgard® 2320 was placed. Then, once the prismatic cell was assembled, liquid medium-A (II) (2.16 ml) was introduced in the prismatic cell to fill the pores of the separator and electrodes not yet filled with Liquid medium-B (I). This amount of electrolyte plus Liquid medium-B (I) already in the electrodes represent a total excess of 107% of the total porosity of the electrochemical core of the cell (electrodes plus the separator).

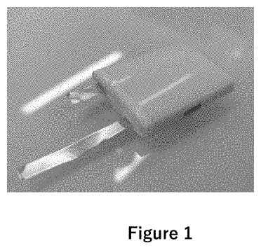

The prismatic cell of Example 1 is shown in FIG. 1.

The discharge capacity values of 4 prismatic cells according to the invention are shown in Table 1 under different discharge rates. It is clear that all of them work properly and that they are reproducible as equivalent cells. All have the same performances.

TABLE 1

| | Discharge capacity (mAh) | | | | |
|---|---|---|---|---|---|
| C-rate | cycle Index | cell 1 | cell 2 | cell 3 | cell 4 |
| C/20-D/20 | 0 | 615 | 623 | 629 | 610 |
| C/10-D/10 | 1 | 621 | 624 | 626 | 613 |
| | 2 | 621 | 623 | 623 | 611 |
| | 3 | 619 | 621 | 619 | 609 |
| | 4 | 615 | 618 | 616 | 608 |
| | 5 | 612 | 615 | 613 | 605 |
| C/5-D/5 | 6 | 606 | 607 | 606 | 600 |
| | 7 | 602 | 603 | 603 | 596 |
| | 8 | 599 | 600 | 600 | 593 |
| | 9 | 596 | 597 | 597 | 590 |
| | 10 | 593 | 594 | 595 | 588 |
| C/5-D/2 | 11 | 556 | 559 | 564 | 558 |
| | 12 | 545 | 547 | 554 | 548 |
| | 13 | 539 | 539 | 547 | 541 |
| | 14 | 534 | 534 | 542 | 537 |
| | 15 | 530 | 530 | 537 | 534 |
| C/5-D | 16 | 355 | 370 | 389 | 373 |
| | 17 | 341 | 360 | 380 | 360 |
| | 18 | 335 | 354 | 374 | 353 |
| | 19 | 331 | 349 | 368 | 349 |
| | 20 | 328 | 343 | 367 | 346 |
| C/5-2D | 21 | 112 | 113 | 127 | 116 |
| | 22 | 110 | 112 | 125 | 114 |
| | 23 | 109 | 111 | 124 | 112 |
| | 24 | 108 | 111 | 123 | 111 |
| | 25 | 107 | 110 | 122 | 110 |

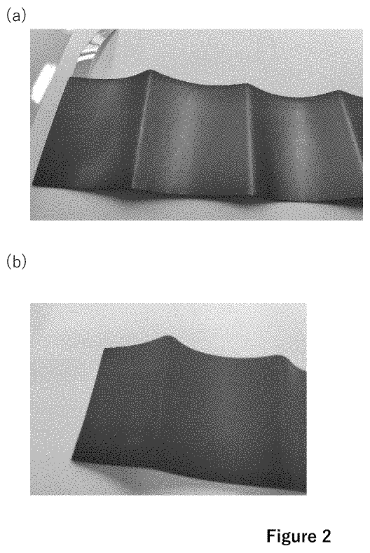

The electrodes of the prismatic cell according to the invention have a very high degree of flexibility. In FIGS. 2 (a) and (b) the electrodes of the prismatic call (anode and cathode, respectively) removed from the prismatic cell after assembly and un-winded are shown. No sign of damage is observed.

### Comparative Example 1: Preparation of Standard Prismatic Cells

Anode Composition and Preparation:

A solution of polymer (FF-B) in NMP (N-Methyl-2-pyrrolidone) was prepared at room temperature under agitation. Then Graphite-A was added to the solution so obtained in a weight ratio of 95/5 (Graphite-A/polymer (FF-B)). The solution mixture was then spread with a constant thickness onto a metal collector (copper foil) using a roll to roll machine. The thickness was controlled by the distance between the knife and the metal collector. So the wet electrode was dried obtaining a final thickness of the anode electrode of 258 microns. The electrode was calendared obtaining finally 5.90 mAh/cm² and 35% of porosity

Cathode Composition and Preparation:

A solution of polymer (FF-B) in NMP was prepared at room temperature under agitation. Then, the carbon black and the active material were added to the solution in the following weights ratios: NMC 622 93 wt %; C65 2 wt %, VGCF 1 wt % and polymer (FF-B) 4 wt %.

The solution mixture was then spread with a constant thickness onto a metal collector (aluminium foil) using a roll to roll machine. The thickness was controlled by the distance between the knife and the metal collector. So the wet electrode was dried obtaining a final thickness of the anode electrode of 219 microns. The electrode was calendared obtaining finally 4.77 mAh/cm² and 28.5% of porosity.

Manufacture of the Li-Ion Battery Prismatic Cell:

Between the cathode and anode a separator Celgard® 2320 was placed. Then, once the prismatic cell was assembled, liquid medium-A (II) was introduced in the prismatic cell with an excess of about 25% more than the total porosity present in the cell, i.e. the sum of the separator and the both electrode porosities (c.a. 2.36 ml).

The discharge capacity values of 6 prismatic cells are shown in Table 2 under different discharge rates. It is clear that not all of them work properly and in any case, they are not reproducible as equivalent cells. All have different performances.

TABLE 2

| | cycle | Discharge capacity (mAh) | | | | | |
|---|---|---|---|---|---|---|---|
| C-rate | Index | cell 1 | cell 2 | cell 3 | cell 4 | cell 5 | cell 6 |
| C/20-D/20 | 0 | 654 | 668 | 678 | 762 | 774 | 773 |
| C/10-D/10 | 1 | 634 | 655 | 671 | 756 | 765 | 768 |
| | 2 | 631 | 654 | 672 | 754 | 763 | 766 |
| | 3 | 629 | 653 | 672 | 0 | 762 | 765 |
| | 4 | 627 | 651 | 671 | | 760 | 764 |
| | 5 | 625 | 651 | 671 | | 758 | 763 |
| C/5-D/5 | 6 | 585 | 634 | 660 | | 751 | 757 |
| | 7 | 578 | 632 | 660 | | 751 | 755 |
| | 8 | 570 | 0 | 659 | | 750 | 755 |
| | 9 | 564 | | 659 | | 750 | 754 |
| | 10 | 557 | | 658 | | 749 | 753 |
| C/5-D/2 | 11 | 420 | | 567 | | 729 | 741 |
| | 12 | 406 | | 562 | | 727 | 739 |
| | 13 | 395 | | 557 | | 726 | 738 |
| | 14 | 385 | | 554 | | 725 | 737 |
| | 15 | 376 | | 550 | | 724 | 737 |
| C/5-D | 16 | 142 | | 241 | | 652 | 687 |
| | 17 | 139 | | 237 | | 650 | 685 |
| | 18 | 138 | | 234 | | 646 | 684 |
| | 19 | 138 | | 231 | | 643 | 683 |
| | 20 | 136 | | 229 | | 642 | 682 |
| C/5-2D | 21 | 47 | | 72 | | 242 | 281 |
| | 22 | 46 | | 72 | | 240 | 280 |
| | 23 | 46 | | 71 | | 238 | 279 |
| | 24 | 46 | | 71 | | 237 | 279 |
| | 25 | 46 | | 71 | | 235 | 278 |

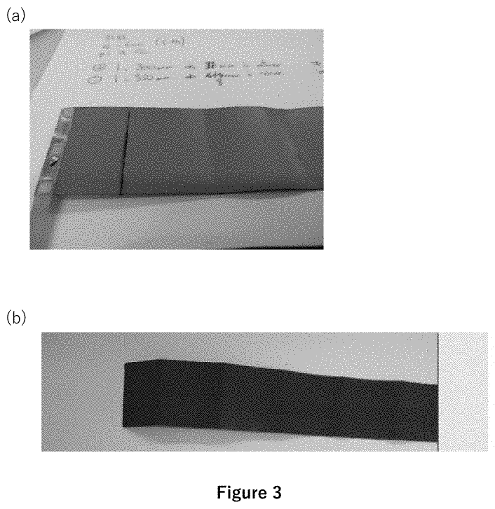

The standard electrodes of the prismatic cell of Comparative Example 1 show lack of flexibility. In FIGS. 3 (a) and (b) the electrodes of the prismatic call (anode and cathode, respectively) removed from the prismatic cell after assembly and un-winded are shown. It can be clearly seen that in correspondence with the regions where the electrodes were bent, when inside the cell, a considerable damage occurred.

### Comparative Example 2

In this example, the procedure of Comparative Example 1 was repeated, but adding an excess amount of electrolyte of about 100% (instead of 25%). The results and lack of reproducibility do not change as shown in Table 3.

TABLE 3

| | | Discharge capacity (mAh) | |
|---|---|---|---|
| C-rate | cycle Index | cell 7 | cell 8 |
| C/20-D/20 | 0 | 536 | 575 |
| C/10-D/10 | 1 | 490 | 569 |
| | 2 | 483 | 567 |
| | 3 | 479 | 565 |
| | 4 | 477 | 563 |
| | 5 | 474 | 561 |
| C/5-D/5 | 6 | 431 | 556 |
| | 7 | 436 | 554 |
| | 8 | 436 | 553 |
| | 9 | 434 | 552 |
| | 10 | 430 | 551 |
| C/5-D/2 | 11 | 219 | 539 |
| | 12 | 206 | 536 |
| | 13 | 201 | 534 |
| | 14 | 200 | 532 |
| | 15 | 202 | 531 |
| C/5-D | 16 | 55 | 392 |
| | 17 | 51 | 386 |
| | 18 | 50 | 381 |
| | 19 | 49 | 379 |
| | 20 | 49 | 377 |
| C/5-2D | 21 | 23 | 146 |
| | 22 | 23 | 143 |
| | 23 | 23 | 142 |
| | 24 | 23 | 140 |
| | 25 | 23 | 140 |

1. An electrochemical device comprising
a) a positive electrode,
b) a negative electrode,
c) a separator, and
d) a liquid electrolyte,
wherein at least one of said positive electrode and said negative electrode is a gelled electrode comprising an electronic conductive substrate and directly adhered onto the electronic conductive substrate, at least one layer of a gelled electrode-forming composition, and wherein the d) liquid electrolyte comprises at least one organic carbonate and/or at least one ionic liquid, and at least one metal salt.

2. The electrochemical device according to claim 1, wherein a gelled electrode-forming composition comprises
i) at least one partially fluorinated fluoropolymer comprising
at least one first recurring unit derived from at least one ethylenically unsaturated fluorinated monomer, and
at least one second recurring unit derived from at least one hydrogenated monomer comprising at least one carboxylic group;
ii) at least one electro-active compound;
iii) a liquid medium (I);
iv) optionally, at least one conductive additive; and
v) optionally, at least an organic solvent (S) different from liquid medium (I),
wherein the liquid medium (I) comprises at least one organic carbonate and/or at least one ionic liquid.

3. The electrochemical device according to claim 1, wherein the c) separator and a liquid medium (II) comprising at least one organic carbonate and/or at least one ionic liquid is placed between the a) positive electrode and the b) negative electrode, and wherein the d) liquid electrolyte is a mixture of the liquid medium (I) and the liquid medium (II).

4. The electrochemical device according to claim 1, wherein the liquid medium (I) and the liquid medium (II) are identical or different, and at least one of the liquid medium (I) and the liquid medium (II) additionally comprise at least one metal salt.

5. The electrochemical device according to claim 1, wherein the at least one of said positive electrode and said negative electrode has thickness between 80 μm and 900 μm.

6. The electrochemical device according to claim 1, wherein the c) separator is a porous polymeric material.

7. The electrochemical device according to claim 2, wherein the at least one first recurring unit is derived from vinylidene fluoride (VDF), chlorotrifluoroethylene (CTFE), hexafluoropropylene (HFP), tetrafluoroethylene (TFE), trifluoroethylene, and combinations thereof.

8. The electrochemical device according to claim 2, wherein the at least one second recurring unit is selected from the group consisting of (meth)acrylic monomers of formula (I): 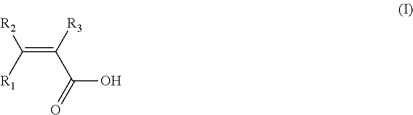
wherein each of R₁, R₂ and R₃, equal to or different from each other, is independently a hydrogen atom or a C₁-C₃ hydrocarbon group.

9. The electrochemical device according to claim 2, wherein the i) partially fluorinated fluoropolymer additionally comprises a third recurring unit derived from at least one fluorinated monomer different from the first recurring unit.

10. The electrochemical device according to claim 2, wherein the ii) at least one electro-active compound is loaded onto the electronic conductive substrate to have an areal capacity between 1.0 mAh/cm².

11. The electrochemical device according to claim 1, wherein the metal salt is selected from the group consisting of:
a) MeI, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(SO₂F)₂]ₙ, Me[N(CF₃SO₂)₂]ₙ, Me[N(C₂F₅SO₂)₂]ₙ, Me[N(CF₃SO₂)(R_{F}SO₂)]ₙ, wherein R_{F} is C₂F₅, C₄F₉ or CF₃OCF₂CF₂, Me(AsF₆)ₙ, Me[C(CF₃SO₂)₃]ₙ, Me₂Sn, wherein Me is a metal and n is the valence of said metal,
b) 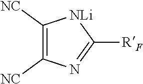
wherein R′ F is selected from the group consisting of F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ and CF₂OCF₃; and
c) combinations thereof.

12. A process for manufacturing an electrochemical device comprising the steps of:
(I) assembling at least
a) a positive electrode;
b) a negative electrode; and
c) a separator interposed between said positive electrode and said negative electrode,
wherein at least one electrode is a gelled electrode obtained by
providing an electronic conductive substrate;
providing a gelled electrode-forming composition;
applying the gelled electrode-forming composition onto the electronic conductive substrate;
optionally, drying the electronic conductive substrate coated with the gelled electrode-forming composition; and
calendaring the same into a film having thickness between 80 μm and 900 μm, and
(II) filling the electrochemical device as assembled with a liquid medium (II) comprising at least one organic carbonate and/or at least one ionic liquid, and optionally at least one metal salt.

13. The process according to claim 12, wherein the gelled electrode-forming composition comprises
i) at least one partially fluorinated fluoropolymer comprising
at least one first recurring unit derived from at least one ethylenically unsaturated fluorinated monomer,
at least one second recurring unit derived from at least one hydrogenated monomer comprising at least one carboxylic group, and
optionally, a third recurring unit derived from at least one fluorinated monomer different from the first recurring units;
ii) at least one electro-active material;
iii) a liquid medium (I) comprising at least one organic carbonate and/or at least one ionic liquid, and optionally at least one metal salt;
iv) optionally, at least one conductive additive, and
v) optionally, at least one organic solvent (S) different from the liquid medium (I).

14. The process according to claim 13, wherein the at least one first recurring unit derived from at least one ethylenically unsaturated fluorinated monomer is VDF.

15. An electrochemical device comprising
a gelled positive electrode comprising an electronic conductive substrate and directly adhered onto the electronic conductive substrate, at least one layer of the gelled electrode-forming composition as defined in claim 1;
a negative electrode;
a porous polymeric material as a separator interposed between said positive electrode and said negative electrode, which is selected from the group consisting of polyethylene, polypropylene, polytetrafluoroethylene, polyvinyl chloride and combinations thereof, and
a liquid electrolyte being a mixture of a liquid medium (I) and a liquid medium (II),
wherein the liquid medium (I) and the liquid medium (II) are identical or different; wherein the liquid medium (I) and the liquid medium (II) respectively comprise at least one organic carbonate and/or at least one ionic liquid, and wherein at least one of the liquid medium (I) and the liquid medium (II) additionally comprise at least one metal salt.
